(19) United States
(12) Patent Application Publication
(10) Pub. No.: US 2019/0198839 A1
(43) Pub. Date: Jun. 27, 2019

(54) SEPARATOR, SECONDARY BATTERY COMPRISING THE SAME, METHOD OF PREPARING THE SEPARATOR, AND METHOD OF MANUFACTURING THE SECONDARY BATTERY

(71) Applicant: Samsung Electronics Co., Ltd., Suwon-si (KR)

(72) Inventors: Ryo IWAMURO, Kanagawa (JP); Hironari TAKASE, Kanagawa (JP); Mitsuharu KIMURA, Kanagawa (JP); Yoshitaka YAMAGUCHI, Kanagawa (JP)

(21) Appl. No.: 16/110,628

(22) Filed: Aug. 23, 2018

(30) Foreign Application Priority Data
Dec. 27, 2017 (JP) 2017-252169
Apr. 16, 2018 (KR) 10-2018-0044112

(51) Int. Cl. H01M 2/16; H01M 2/14; H01M 10/0585

(52) U.S. Cl. CPC H01M 2/1666; H01M 2/145; H01M 10/0585; H01M 2/1653; H01M 2/1626

(57) ABSTRACT

A separator including: a cellulose fiber nonwoven fabric; and a fluorine-containing resin layer including a fluorine-containing copolymer, the fluorine-containing resin layer being disposed on a surface of the cellulose fiber nonwoven fabric, wherein the fluorine-containing copolymer includes a copolymer including vinylidene fluoride and a fluorine-containing monomer other than vinylidene fluoride.

### CROSS-REFERENCE TO RELATED APPLICATIONS

This application claims priority to and the benefit of Japanese Patent Application No. 2017-252169, filed on Dec. 27, 2017, in the Japanese Patent Office, and Korean Patent Application No. 10-2018-0044112, filed on Apr. 16, 2018, in the Korean Intellectual Property Office, and all the benefits accruing therefrom under 35 U.S.C. § 119, the contents of both of which are incorporated herein in their entireties by reference.

### BACKGROUND

### 1. Field

The present disclosure relates to a separator, a secondary battery including the same, methods of preparing the separator, and methods of manufacturing the secondary battery.

### 2. Description of the Related Art

Secondary batteries have been widely used in mobile electronic devices, electric vehicles, hybrid vehicles, and the like. Among them, extensive research and development have been conducted on nonaqueous electrolyte secondary batteries such as lithium ion batteries having high energy density.

Polyolefin-based separators comprised of a polyolefin such as polyethylene or polypropylene, which is inexpensive, chemically stable, and has excellent mechanical properties, have been widely used as separators of nonaqueous electrolyte secondary batteries.

However, polyolefin-based separators may not be used in a case in which heat resistance is desirable at a temperature of 200° C. or higher, for example, in a vehicle. Thus, there is still a need for an improved separator, a secondary battery including the same, a method of preparing the separator, and a method of manufacturing of the secondary battery.

### SUMMARY

Provided is a separator.

Provided is a secondary battery including the separator.

Provided are methods of preparing the separator.

Provided are methods of manufacturing the secondary battery.

Additional aspects will be set forth in part in the description which follows and, in part, will be apparent from the description, or may be learned by practice of the presented embodiments.

According to an aspect of an embodiment, a separator includes a cellulose fiber nonwoven fabric, and a fluorine-containing resin layer including a fluorine-containing copolymer, the fluorine-containing resin layer being disposed on a surface of the cellulose fiber nonwoven fabric, wherein the fluorine-containing copolymer includes a copolymer including vinylidene fluoride and a fluorine-containing monomer other than vinylidene fluoride.

According to an aspect of another embodiment, a secondary battery includes a positive electrode, a negative electrode, and the separator interposed between the positive electrode and the negative electrode.

According to an aspect of another embodiment, a method of preparing a separator includes: coating a solution including a cellulose fiber suspension and a water-soluble pore-forming agent to form a cellulose fiber nonwoven fabric; combining a copolymer comprising vinylidene fluoride and a fluorine-containing monomer other than vinylidene fluoride to form a fluorine-containing resin layer forming composition; and coating the fluorine-containing resin layer forming composition on a surface of the cellulose fiber nonwoven fabric to form a coated composition; and drying the coated composition to prepare the separator.

According to an aspect of another embodiment, a method of manufacturing a secondary battery includes: sequentially laminating a positive electrode, the separator, and a negative electrode to form a laminate; and disposing an electrolytic solution in the laminate to manufacture the secondary battery, wherein a fluorine-containing resin layer of the separator faces the positive electrode.

### BRIEF DESCRIPTION OF THE DRAWINGS

These and/or other aspects will become apparent and more readily appreciated from the following description of the embodiments, taken in conjunction with the accompanying drawings in which:

FIG. 1A schematically illustrates an embodiment of a structure of a separator;

FIG. 1B schematically illustrates an embodiment in which a hydroxyl group (—OH) of a surface of a cellulose fiber nonwoven fabric forms a hydrogen bond with a carboxyl group (—COOH) which is a polar group at a surface of a fluorine-containing resin layer in a separator;

FIG. 1C schematically illustrates an embodiment of a secondary battery (laminated cell);

FIG. 2 is a scanning electron microscope (“SEM”) image of a cross-section of a separator facing a positive electrode of a secondary battery manufactured in Example 1;

FIGS. 3A and 3B are graphs illustrating results of absorbance (arbitrary units (a.u.)) versus wave number (centimeters⁻¹ (cm⁻¹)) of nanoscale Fourier-transform infrared spectroscopy (“FTIR”) spectrum analysis of surfaces of separators facing positive electrodes in secondary batteries manufactured in Example 1 and Comparative Example 1;

FIG. 4 is a graph illustrating evaluation results of cycle characteristics (capacity retention ratio (%)) versus number of cycles of the secondary batteries manufactured in Example 1 and Comparative Example 1;

FIG. 5 is an illustration of an embodiment of a secondary battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a separator, a secondary battery including the same, a method of preparing the separator, and a method of manufacturing the secondary battery according to embodiments of the present disclosure will be described in further detail with reference to the accompanying drawings. However, the scope of the disclosure is not limited thereby but defined by the appended claims.

An expression used in the singular encompasses the expression of the plural, unless it has a clearly different meaning in the context. In the present specification, it is to be understood that the terms such as “including” or “having,” etc., are intended to indicate the existence of the features, numbers, operations, components, parts, elements, materials, or combinations thereof disclosed in the specification, and are not intended to preclude the possibility that one or more other features, numbers, operations, components, parts, element, materials, or combinations thereof may exist or may be added.

In the drawings, thicknesses of layers and regions may be enlarged or reduced to clearly illustrate the layers and regions. Like reference numerals in the drawings denote like elements. It will also be understood that when an element such as a layer, a film, a region, or a plate is referred to as being “on” another element, it can be directly on the other element, or intervening elements may also be present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.”

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Research into separator materials having excellent heat resistance and that may replace polyolefin-based separators has been conducted. Among them, cellulose has drawn attention due to thermal stability thereof up to a temperature of about 300° C. and sustainability thereof since cellulose is derived from wood.

However, cellulose has a large number of hydroxyl groups (—OH) in molecules thereof and weak voltage resistance to a high voltage (≥4.2 volts (V)). In other words, cellulose is denatured by oxidation reactions in which a high voltage is applied, and thus lifespan and physical strength of batteries including the same may deteriorate resulting in short circuits.

To improve these properties, techniques of coating surfaces of separators including cellulose with another material have recently drawn attention. Examples of the separator of this type include a separator having a coating layer comprised of a mixture of inorganic particles and an organic binder on a porous substrate of cellulose such as a nonwoven fabric, a separator having a porous polyolefin-based layer formed on a cellulose-containing fiber layer, or a separator including cellulose surface-modified with a silane coupling agent.

However, even when such separators are used, only one of heat resistance and voltage resistance may be improved and/or adhesion with a substrate may decrease.

Provided is a separator to improve the above-mentioned properties.

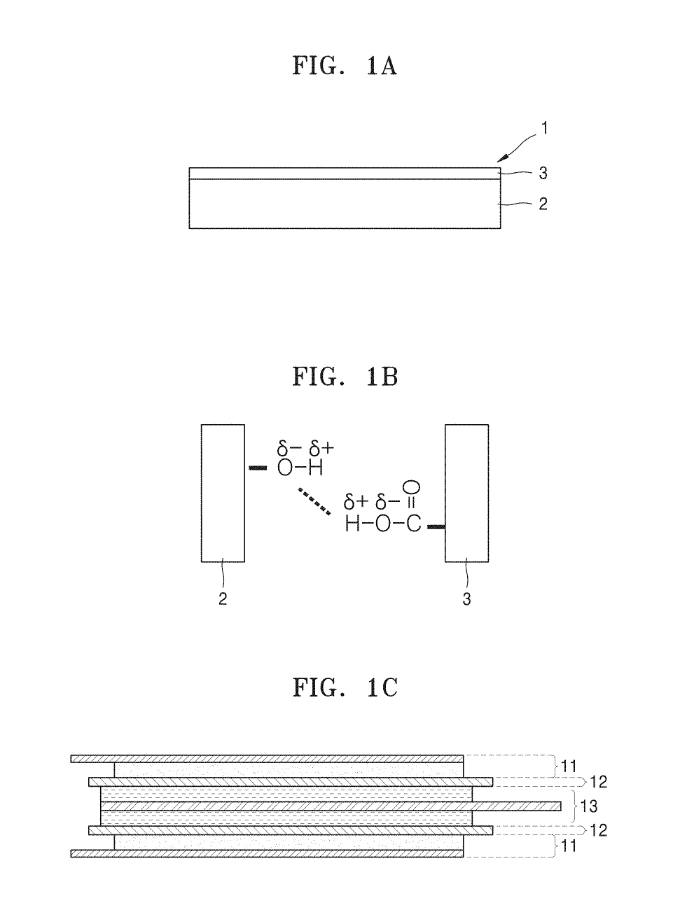

FIG. 1A schematically illustrates a structure of a separator 1 according to an embodiment.

Referring to FIG. 1A, the separator 1 according to an embodiment includes a cellulose fiber nonwoven fabric 2, and a fluorine-containing resin layer 3 including a fluorine-containing copolymer, the fluorine-containing resin layer being located on at least one surface of the cellulose fiber nonwoven fabric 2, wherein the fluorine-containing copolymer includes a copolymer including vinylidene fluoride and a fluorine atom-containing monomer other than vinylidene fluoride.

Hereinafter, the cellulose fiber nonwoven fabric 2 and the fluorine-containing resin layer 3 of the separator 1 will be described.

### Separator 1

### Cellulose Fiber Nonwoven Fabric 2

The cellulose fiber nonwoven fabric 2 may be used as a material constituting the separator 1 according to an embodiment. The separator 1 including the cellulose fiber nonwoven fabric 2 has excellent heat resistance.

Throughout the specification, the term “excellent heat resistance” refers to excellent thermally stability at a temperature of 200° C. or higher, for example, 300° C. or higher.

Cellulose used as a raw material of the cellulose fiber nonwoven fabric 2 is not particularly limited and may be, for example, natural cellulose isolated from biosynthesis products of plants, animals, and bacterial gel and purified. For example, cotton pulp such as softwood pulp, hardwood pulp, and cotton linter; non-wood pulp such as straw pulp and bagasse pulp; bacterial cellulose; and cellulose isolated from seaweed may be used.

The cellulose fiber nonwoven fabric 2 may be, for example, a microorganism-based cellulose fiber nonwoven fabric. The microorganism-based cellulose fiber nonwoven fabric may be, for example, a cellulose fiber nonwoven fabric produced by using acetic acid bacteria (Acetobacter).

The cellulose fiber nonwoven fabric 2 may include cellulose fibers having an average fiber diameter of about 3 nanometers (nm) to about 300 nm. When the average fiber diameter is within this range, a separator including the same may have sufficient, e.g., desirable, ionic conductivity.

The cellulose fiber nonwoven fabric 2 may include 90% by weight or greater, for example 95% by weight or greater, of cellulose fibers having an average fiber diameter of 1 micrometer (μm) or less. The cellulose fiber nonwoven fabric 2 may include 80% by weight or greater of cellulose fibers having an average fiber diameter of 500 nm or less. By reducing a ratio of cellulose fibers having a relative large average fiber diameter, thickness, pore diameter, and air permeability, and the like thereof may be more easily controlled during film formation as separators.

The average fiber diameter of the cellulose fibers may be measured by observing cellulose fibers in a separator or a film formed by casting a diluted solution of cellulose fibers and drying the solution with a transmission electron microscope (“TEM”), a scanning electron microscope (“SEM”), or a combination thereof. A ratio of fibers having an average fiber diameter less than 1 μm may be obtained by comprehensively evaluating viscosity of about 0.1% by weight to 2% or less by weight of a water dispersion of cellulose fibers (E-type or B-type viscometer), tensile strength, and surface area of a porous film. For example, see International Publication WO 2013/054884.

The cellulose fiber nonwoven fabric 2 may have a thickness of 5 μm or greater, for example, 10 μm or greater, to maintain insulating properties and a thickness of 30 μm or less, for example, 20 μm or less to improve energy densities of batteries.

### Fluorine-Containing Resin Layer 3

The separator 1 may include the fluorine-containing resin layer 3 including the fluorine-containing copolymer located on at least one surface of the cellulose fiber nonwoven fabric 2. The separator 1 including the fluorine-containing resin layer 3 has excellent voltage resistance.

Throughout the specification, the term “excellent voltage resistance” refers to excellent electrochemical stability at a high voltage of 4.2 V or higher.

The fluorine-containing resin layer 3 may have a thickness of about 0.1 μm to 1 μm or less. When the thickness of the fluorine-containing resin layer 3 is within this range, an increase in air permeability may be suppressed and movement of ions, e.g., lithium ions, between electrodes may not be blocked. Thus, a secondary battery including the same may have excellent battery performance (cycle characteristics). The fluorine-containing resin layer 3 may have a thickness of 0.1 μm or greater, for example, 0.2 μm or greater, or for example, 0.3 μm or greater to improve voltage resistance and a thickness less than 1 μm or less to improve battery performance by inhibiting the increase in air permeability.

The fluorine-containing resin layer 3 may include the fluorine-containing copolymer including a copolymer including vinylidene fluoride and the fluorine atom-containing monomer other than vinylidene fluoride.

Since the fluorine-containing copolymer is a copolymer including vinylidene fluoride and the fluorine atom-containing monomer other than vinylidene fluoride, dehydrofluorination may occur less frequently, may have higher electrochemical stability at a high voltage and better voltage resistance, and may improve battery performance of a secondary battery including the same in comparison with a homopolymer of vinylidene fluoride (polyvinylidene fluoride).

An amount of the fluorine-containing copolymer may be from about 50% by weight to about 100% by weight based on a total weight of the fluorine-containing resin layer 3. When the amount of the fluorine-containing copolymer is within this range, compatibility (wettability) with an electrolytic solution and oxidation resistance may be improved.

The fluorine atom-containing monomer other than vinylidene fluoride may include a monomer of trifluoroethylene, chlorotrifluoroethylene, tetrafluoroethylene, hexafluoropropylene, fluoromethylvinylether, fluoroethylvinylether, fluoropropylvinylether, or a combination thereof. The fluorine atom-containing monomer other than vinylidene fluoride may include hexafluoropropylene to improve oxidation resistance.

The fluorine-containing copolymer may include a vinylidene fluoride/trifluoroethylene copolymer, a vinylidene fluoride/chlorotrifluoroethylene copolymer, a vinylidene fluoride/tetrafluoroethylene copolymer, a vinylidene fluoride/hexafluoropropylene copolymer, a vinylidene fluoride/fluoromethylvinylether copolymer, a vinylidene fluoride/fluoroethylvinylether copolymer, a vinylidene fluoride/fluoropropylvinylether copolymer, or the like. These fluorine-containing copolymers may be used alone or in combination of at least two thereof. The fluorine-containing copolymer may include the vinylidene fluoride/hexafluoropropylene copolymer to improve oxidation resistance.

A molar ratio of vinylidene fluoride to the fluorine atom-containing monomer other than vinylidene fluoride may be from about 70:30 to about 99.9:0.1, for example, from about 80:20 to about 99.5:0.5. When the molar ratio of vinylidene fluoride to the fluorine atom-containing monomer other than vinylidene fluoride is within the ranges described above, voltage resistance may be improved.

A weight average molecular weight Mw of the fluorine-containing copolymer may be from about 1,000 grams per mole (g/mol) to about 10,000,000 g/mol. The weight average molecular weight Mw of the fluorine-containing copolymer may be, for example, from about 5,000 g/mol to about 5,000,000 g/mol, for example, from about 10,000 g/mol to about 3,000,000 g/mol. When the weight average molecular weight Mw of the fluorine-containing copolymer is within the ranges described above, adhesion to the cellulose fiber nonwoven fabric may be improved. Throughout the specification, the weight average molecular weight Mw of the fluorine-containing copolymer refers to a weight average molecular weight (in conversion of polystyrene) measured by gel permeation chromatography (“GPC”) determined in tetrahydrofuran at 40° C.

An amount of vinylidene fluoride may be from about 50% by weight to about 95% by weight, for example, from about 60% by weight to about 90% by weight, or from about 70% by weight to about 85% by weight, based on a total weight of the fluorine-containing copolymer. When the amount of vinylidene fluoride is within the ranges described above, compatibility (wettability) with an electrolytic solution and oxidation resistance may be improved.

An amount of the fluorine atom-containing monomer other than vinylidene fluoride may be from about 1% by weight to about 50% by weight, for example, from about 5% by weight to about 35% by weight, or from about 10% by weight to about 25% by weight based on the total weight of the fluorine-containing copolymer. When the amount of the fluorine atom-containing monomer other than vinylidene fluoride is within the ranges described above, electrochemical stability and voltage resistance at a high voltage may be improved.

The fluorine-containing resin layer 3 may have at least one polar group capable of forming hydrogen bonds with cellulose fibers on the surface thereof. Cellulose fibers may be bonded to each other via hydrogen bonds due to hydroxyl groups (—OH) present on the surfaces thereof, causing hardening, breaking, or shut down. Since surfaces of the cellulose fiber nonwoven fabric 2 and a positive electrode are hydrophilic, the fluorine-containing resin layer 3 according to an embodiment having at least one polar group capable of forming hydrogen bonds with cellulose fibers may have improved adhesion and improved voltage resistance.

To this end, the fluorine-containing resin layer 3 may include a fluorine-containing copolymer including the fluorine atom-containing monomer other than vinylidene fluoride, a polar group-containing monomer, or a monomer of a combination thereof. Since the fluorine-containing resin layer 3 includes the fluorine-containing copolymer including the polar group-containing monomer, the surface of the fluorine-containing resin layer 3 may have at least one polar group on the surface thereof in addition to the fluorine atom-containing monomer other than vinylidene fluoride.

The polar group-containing monomer refers to a group including an atom with an electronegativity different from that of a carbon atom. The polar group-containing monomer may be a monomer including a functional group of a halogen group, a hydroxyl group (—OH), an amino group (—NH₂), a nitro group (—NO₂), a carboxyl group (—COOH), a formyl group (—CHO), a substituted or unsubstituted C1-C10 alkoxy group (—OR), a substituted or unsubstituted C1-C10 ester group (—COOR), and a nitrile group (—CN), or a combination thereof. The polar group-containing monomer may include a monomer having a carboxyl group (—COOH) among them to improve the ability of forming hydrogen bonds with the cellulose fiber nonwoven fabric 2 to improve oxidation resistance.

Throughout the specification, the tem “substituted” indicates that at least one hydrogen atom included in a functional group is substituted with a halogen atom, a C1-C10 alkyl group substituted with a halogen atom (e.g.: CCF₃, CHCF₂, CH₂F, and CCl₃), a C1-C10 alkoxy group, a C2-C10 alkoxyalkyl group, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group and a salt thereof, a phosphoric acid group and a salt thereof, a C1-C10 alkyl group, a C2-C10 alkenyl group, a C2-C10 alkynyl group, a C1-C10 heteroalkyl group, a C6-C20 aryl group, a C6-C20 arylalkyl group, a C6-C20 heteroaryl group, a C7-C20 heteroarylalkyl group, a C6-C20 heteroaryloxy group, a C6-C20 heteroaryloxyalkyl group, or a C6-C20 heteroarylalkyl group.

The “halogen atom” includes fluorine, bromine, chlorine, and iodine.

The term “alkyl” refers to a completely saturated, branched or unbranched (or straight-chain or linear) hydrocarbon. Examples of the “alkyl” may be, but are not limited to, methyl, ethyl, n-propyl, isopropyl, n-butyl, isobutyl, sec-butyl, n-pentyl, isopentyl, neopentyl, iso-amyl, n-hexyl, 3-methylhexyl, 2,2-dimethylpentyl, 2,3-dimethylpentyl, or n-heptyl.

The term “alkoxy” and “aryloxy” refer to alkyl or aryl linked to an oxygen atom, respectively.

The term “alkenyl” refers to a branched or unbranched hydrocarbon having at least one carbon-carbon double bond. Examples of the “alkenyl” may be, but are not limited to, vinyl, allyl, butenyl, isopropenyl, or isobutenyl.

The term “alkynyl” refers to a branched or unbranched hydrocarbon having at least one carbon-carbon triple bond. Examples of the “alkynyl” may be, but are not limited to, ethynyl, butynyl, isobutynyl, or isopropynyl.

The term “aryl” refers to a carbocyclic aromatic system in which an aromatic ring is fused to at least one carbon ring. Examples of the “aryl” may be, but are not limited to, phenyl, naphthyl, or tetrahydronaphthyl.

The term “heteroaryl” refers to a monocyclic or bicyclic organic compound including a heteroatom of N, O, P, S, or a combination thereof with the remaining ring atoms being carbon atoms. For example, a heteroaryl group may include 1 to 5 heteroatoms and 5 to 10 ring members. The S or N may be oxidized to have various oxidation states.

Examples of the “heteroaryl” may be, but are not limited to, thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazine-2-yl, pyrazine-4-yl, pyrazine-5-yl, 2-pyrimidine-2-yl, 4-pyrimidine-2-yl, or 5-pyrimidine-2-yl.

FIG. 1B schematically illustrates that a hydroxyl group (—OH) of the surface of the cellulose fiber nonwoven fabric 2 forms a hydrogen bond with a carboxyl group (—COOH), as a polar group, of the surface of the fluorine-containing resin layer 3 in the separator 1 according to an embodiment.

Referring to FIG. 1B, since a hydrophilic hydroxyl group (—OH) of the surface of the cellulose fiber nonwoven fabric 2 forms a hydrogen bond with a polar carboxyl group (—COOH) of the surface of the fluorine-containing resin layer 3 in the separator 1 according to an embodiment, adhesion therebetween may be improved.

The polar group-containing monomer may include a monomer of acrylic acid, methacrylic acid, furoic acid, crotonic acid, itachonic acid, maleic acid, fumaric acid, citraconic acid, an anhydrate thereof, a monoester thereof, or a combination thereof.

As used herein, the term “(meth)acrylic acid” refers to acrylic acid or methacrylic acid. Acrylic acid and methacrylic acid may be used alone or in combination of at least two thereof.

An amount of the polar group-containing monomer may be from about 0% by weight to about 10% by weight, for example, from about 1% by weight to about 8% by weight, or for example, 1% by weight to about 5% by weight based on the total weight of the fluorine-containing copolymer. When the amount of the polar group-containing monomer is within the ranges described above, adhesion to the cellulose fiber nonwoven fabric 2 and the positive electrode may be improved.

A fluorine-containing copolymer having a polar group may be, for example, a commercially available dicarboxylic acid-modified vinylidene fluoride/hexafluoropropylene copolymer or a monocarboxylic acid-modified vinylidene fluoride/hexafluoropropylene copolymer, without being limited thereto. The fluorine-containing copolymer having a polar group may be used alone or in combination of at least two thereof.

The fluorine-containing copolymer having a polar group may be prepared by copolymerization of monomer components including vinylidene fluoride, the fluorine atom-containing monomer other than vinylidene fluoride, the polar group-containing monomer, and, if desired, other monomers by various polymerization methods such as emulsion polymerization, solution polymerization, and suspension polymerization.

The fluorine-containing resin layer 3 may include any other suitable resins in addition to the fluorine-containing copolymer. The resins may be, for example, a polyolefin-based resin such as a polyethylene-based resin and a polypropylene-based resin and a homopolymer of vinylidene fluoride (polyvinylidene fluoride), without being limited thereto.

The fluorine-containing resin layer 3 may be, for example, in the form of a film or a sheet, although the form is not limited thereto.

The separator may have an air permeability of about 50 seconds (sec)/100 milliliters (mL) to about 500 sec/100 mL. When the air permeability of the separator is within this range, pore sizes of the separator may be sufficiently maintained to prevent short-circuiting caused by inert lithium and to maintain or improve ionic conductivity.

Throughout the specification, the “air permeability” refers to a value measured according to JIS P8117.

### Secondary Battery

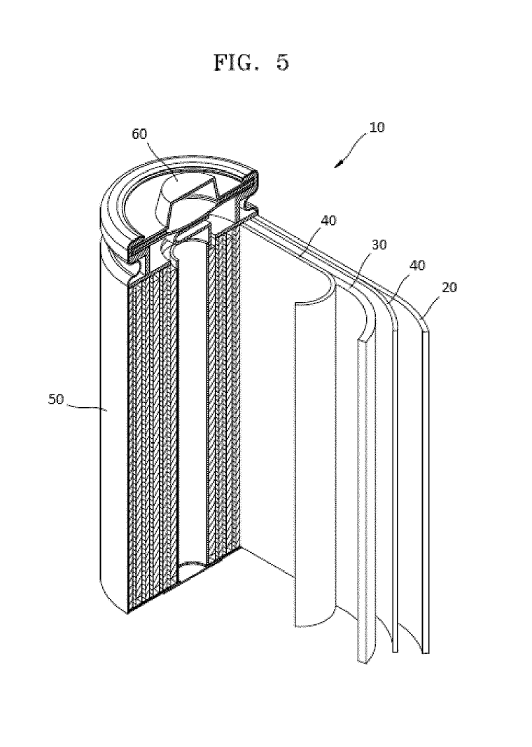

As shown in FIG. 5, a secondary battery 10 according to another embodiment may include a positive electrode 20, a negative electrode 30, and the above-described separator 40 located between the positive electrode and the negative electrode. The battery may comprise a case 50 serving as a negative terminal and a header 60 serving as a positive terminal.

### Positive Electrode

A positive electrode is prepared according to the following manufacturing method.

A positive active material, a conductive agent, a binder, and a solvent are mixed to prepare a positive active material composition. A positive electrode plate is prepared by forming a positive active material layer by applying the positive active material composition to an aluminum current collector directly, i.e., by using an applicator, and drying the composition to remove water that is a solvent, with a thermostat. In an embodiment, a positive electrode plate may be prepared by forming a positive active material layer by coating the positive active material composition on a separate support by using an applicator or the like and drying the composition to remove water, as a solvent, with a thermostat, and then laminating a positive active material film separated from the support on an aluminum current collector. The positive electrode is not limited to the above-described form and may also have any other suitable forms.

The positive active material may be: lithium metal oxide, such as lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate; nickel sulfide; copper sulfide; sulfuric acid; iron oxide; or vanadium oxide. However, the positive active material is not limited thereto and any suitable material may also be used.

Examples of the positive active material may include one of the compounds represented by the following formulae: LiₐA_{1-b}B′_{b}D′₂ (where 0.90≤a≤1.8 and 0≤b≤0.5); LiₐE_{1-b}B′_{b}O_{2-c}D′_{c} (where 0.90≤a≤1.8, 0≤b≤0.5, and 0≤c≤0.05); LiE_{2-b}B′_{b}O_{4-c}D′_{c} (where 0≤b≤0.5 and 0≤c≤0.05); LiₐNi_{1-b-c}Co_{b}B′_{c}D′_{α} (where 0.90≤a≤1.8, 0≤b≤0.5, 0≤c≤0.05, and 0<α≤2); LiₐNi_{1-b-c}Co_{B}′_{c}O_{2-α}F′_{α} (where 0.90≤a≤1.8, 0≤b≤0.5, 0≤c≤0.05, and 0<α≤2); LiₐNi_{1-b-c}Co_{b}B′_{c}O_{2-α}F′₂ (where 0.90≤a≤1.8, 0≤b≤0.5, 0≤c≤0.05, and 0<α<2); LiₐNi_{1-b-c}Mn_{b}B′_{c}D′_{α} (where 0.90≤a≤1.8, 0≤b≤0.5, 0≤c≤0.05, and 0<α≤2); LiₐNi_{1-b-c}Mn_{b}B′_{c}O_{2-α}F′_{α} (where 0.90≤a≤1.8, 0≤b≤0.5, 0≤c≤0.05, and 0<α<2); LiₐNi_{1-b-c}Mn_{b}B′_{c}O_{2-α}F′₂ (where 0.90≤a≤1.8, 0≤b≤0.5, 0≤c≤0.05, and 0<α<2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄.

In the formulae, A is Ni, Co, Mn, or any combination thereof; B′ is Al, Ni, Co, Mn, Cr, Fe, Mg, Sr, V, a rare earth element, or any combination thereof; D′ is O, F, S, P, or any combination thereof; E is Co, Mn, or any combination thereof; F′ is F, S, P, or any combination thereof; G is Al, Cr, Mn, Fe, Mg, La, Ce, Sr, V, or any combination thereof; Q is Ti, Mo, Mn, or any combination thereof; I′ is Cr, V, Fe, Sc, Y, or any combination thereof; and J is V, Cr, Mn, Co, Ni, Cu, or any combination thereof.

The compounds listed above may have a coating layer on the surface thereof. In an embodiment, a mixture of a compound with no coating layer and a compound having a coating layer, the compounds being of the compounds listed above, may be used. The coating layer may include a compound of a coating element, such as an oxide, hydroxide, oxyhydroxide, oxycarbonate, or hydroxycarbonate of the coating element. The compound constituting the coating layer may be amorphous or crystalline. Examples of the coating element contained in the coating layer may be Mg, Al, Co, K, Na, Ca, Si, Ti, V, Sn, Ge, Ga, B, As, Zr, or a mixture thereof. The coating layer may be formed on the compound, used as the positive active material, by using the coating element via any suitable method, which does not adversely affect physical properties of the positive active material (for example, a spray coating method and an immersion method).

These positive active materials may be used alone or in combination of at least two thereof.

The conductive agent may be acetylene black, natural graphite, artificial graphite, carbon black, Ketchen black, carbon fiber, a metal such as copper, nickel, aluminum, and silver, each of which is used in powder or fiber form, or a mixture of one or more conductive materials such as polyphenylene derivatives. However, the conductive agent is not limited thereto and any suitable material may also be used. A crystalline carbonaceous material may be added thereto as the conductive agent.

The binder may be a vinylidene fluoride/hexafluoropropylene copolymer, polyvinylidene fluoride (“PVDF”), polyacrylonitrile, polymethylmethacrylate, polytetrafluoroethylene and a mixture thereof, a styrene butadiene rubber polymer, or the like. However, the binder is not limited thereto and any suitable binder may also be additionally used.

The solvent may be N-methyl pyrrolidone, acetone, or water. However, the solvent is not limited thereto and any suitable solvent may also be used.

Any suitable amounts of the positive active material, the conductive agent, the binder, and the solvent may be used. At least one of the conductive agent and the solvent may not be used according to the use and structure of the secondary battery.

Thickness of the positive active material layer is not particularly limited. A porous insulating layer may be formed on the positive active material layer.

### Negative Electrode

The negative electrode may be prepared in the same manner as in the preparation of the positive electrode, except that a negative active material is used instead of the positive active material. The same conductive agent, binder, and solvent as for the positive electrode may be used in a negative active material composition.

Examples of the negative active material may include a metallic active material or a carbonaceous active material. Examples of the metallic active material may include a metal such as lithium, indium, aluminum, tin, and silicon or an alloy thereof, without being limited thereto. The carbonaceous active material may be, for example, artificial graphite, graphite carbon fiber, resin-sintered carbon, carbon grown by vapor-phase thermal decomposition, coke, mesophase carbon microbeads, furfuryl alcohol resin-sintered carbon, polyacene, pitch-based carbon fiber, vapor grown carbon fiber, natural graphite, or non-graphitizable carbon. However, the negative active material is not limited thereto and any suitable negative active materials may also be used.

These negative active materials may be used alone or in combination of at least two thereof.

For example, the negative electrode may be prepared according to the following method.

A negative active material such as natural graphite, artificial graphite, or a mixture thereof, a binder such as a styrene-butadiene copolymer latex, a conductive agent that assists electronic conductivity, and an auxiliary agent of carboxymethyl cellulose sodium salt that improves dispersibility in water are dispersed in a water-soluble solvent to prepare a negative active material composition. A negative active material layer is prepared by coating the negative active material composition on a copper foil, as a current collector, by using an applicator or the like and drying the coated composition to remove water, as a solvent, with a thermostat.

Any suitable amounts of the negative active material, the conductive agent, the binder, the solvent, and the auxiliary agent may be used. At least one of the conductive agent, the solvent, and the auxiliary agent may not be used according to the use and structure of the secondary battery.

Thickness of the negative active material layer is not particularly limited. A porous insulating layer may be formed on the negative active material layer.

### Electrolytic Solution

Next, an electrolytic solution may be prepared. The electrolytic solution may be prepared by dissolving a lithium salt in an organic solvent.

Any suitable organic solvent may be used. For example, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or any mixtures thereof.

The lithium salt may also be any suitable lithium salt. The lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (x and y are each independently a natural number), LiCl, LiI, or any mixture thereof.

A concentration of the lithium salt may be from about 0.1 molar (M) to about 2 M. When the concentration of the lithium salt is within this range, the electrolytic solution may have appropriate conductivity and viscosity. Thus, the electrolytic solution may have excellent performance and allow effective movement of lithium ions.

### Structure of Secondary Battery

The fluorine-containing resin layer 3 may be located at a position of between the positive electrode and the separator 1, between the negative electrode and the separator 1, or a combination thereof. The fluorine-containing resin layer 3 may be located between the positive electrode and the separator to prevent oxidation of the positive electrode and improve electrochemical stability (voltage resistance) at a high voltage applied thereto. The fluorine-containing resin layer 3 may be located only between the positive electrode and the separator to prevent an increase in air permeability, to form a thin film of a nonaqueous electrolyte secondary battery, and to reduce manufacturing costs.

The form of the secondary battery according to an embodiment is not particularly limited and may be, for example, a jelly roll type, a stack type, a stack folding type, or a lamination stack type.

The secondary battery according to an embodiment may be manufactured in such a manner that an electrode assembly including the positive electrode, the negative electrode, and the separator 1 according to an embodiment is stored in a battery case together with an electrolytic solution. The electrode assembly has a structure in which the positive electrode and the negative electrode are wound or stacked in a predetermined shape with the separator according to an embodiment interposed therebetween.

The secondary battery may be formed as a unit cell having a positive electrode/separator/negative electrode structure, a bi-cell having a positive electrode/separator/negative electrode/separator/positive electrode structure, or a laminated battery having repeated unit cell structures.

The secondary battery may be in the form of, for example, a coin, a button, a sheet, a stack, a cylinder, a plane, a square, or a horn, but the form of the secondary battery is not limited thereto. The secondary battery may be applied to large-sized batteries used in electric vehicles, or the like.

The secondary battery according to an embodiment may be, for example, a stacking battery. The secondary battery may be a lithium secondary battery. The lithium secondary battery may be a lithium ion battery, a lithium polymer battery, a lithium sulfur battery, or a lithium air battery.

FIG. 1C schematically illustrates a secondary battery (laminated cell) 10 according to an embodiment.

Referring to FIG. 1C, a separator including the fluorine-containing resin layer 3 may be laminated on one surface of the positive electrode facing the separator 1. A separator including the fluorine-containing resin layer 3 may be laminated on one surface of the separator 1 facing the positive electrode. These laminating arrangements of the fluorine-containing resin layer 3 are the same in terms of the structure in which the fluorine-containing resin layer 3 is located between the positive electrode and the separator 1. Thus, the separator including the fluorine-containing resin layer 3 may have the same effect in terms of improving productivity and processibility such as thickness adjustment.

### Method of Preparing Separator

A method of preparing a separator according to another embodiment may include obtaining a cellulose fiber nonwoven fabric by using a coating solution including a cellulose fiber suspension and a water-soluble pore-forming agent, preparing a fluorine-containing resin layer forming composition by using a fluororesin solution including a copolymer including vinylidene fluoride and a fluorine atom-containing monomer other than vinylidene fluoride, and preparing the separator by forming a fluorine-containing resin layer by coating the fluorine-containing resin layer forming composition on at least one surface of the cellulose fiber nonwoven fabric or at least one surface of the positive electrode and drying the coated resin.

### Obtaining of Cellulose Fiber Nonwoven Fabric

A cellulose fiber nonwoven fabric is obtained by using a coating solution including a cellulose fiber suspension and a water-soluble pore-forming agent.

The obtaining of the cellulose fiber nonwoven fabric may include a process of applying the coating solution including the cellulose fiber suspension and the water-soluble pore-forming agent to a substrate, a process of forming a cellulose fiber film by drying the substrate coated with the coating solution, and a process of separating the formed cellulose fiber film from the substrate.

First, the obtaining of the cellulose fiber nonwoven fabric may be performed according to the following processes.

An aqueous suspension of cellulose fibers having a predetermined concentration is prepared. The concentration of cellulose fibers in a solution may also be appropriately adjusted according to a coating method. Although water may be used as a solvent of the solution for easy handling and cost reduction, any suitable solvent having a higher vapor pressure than water may also be used.

Next, the water-soluble pore-forming agent and, if desired, a polymer, are added to the prepared aqueous suspension of cellulose fibers and the mixed suspension is treated with a disperser (e.g., high pressure homogenizer) a predetermined number of times and sufficiently stirred to prepare a coating solution including cellulose fibers (e.g., cellulose nanofibers).

In the case in which the polymer and the like are added to the aqueous suspension of cellulose fibers, the order of adding the polymer and the like and the water-soluble pore-forming agent is not limited and the polymer and the like and the water-soluble pore-forming agent may be added simultaneously.

Examples of the disperser may include a screw type mixer, a paddle type mixer, a disper type mixer, and a turbine type mixer, without being limited thereto. By using a device having strong beating ability such as a homo mixer with a high-rotation, a high pressure homogenizer, an ultrasonic dispersion processor, a beater, a disc type refiner, a conical type refiner, a double disc-type refiner, or a grinder, as the disperser, a coating solution including finer cellulose fibers may be obtained.

Next, the coating solution prepared as described above is applied to a substrate. A material used to form the substrate may include, for example, polyesters such as polyethylene terephthalate, polyethylene naphthalate, and polylactic acid; polyolefins such as polyethylene and polypropylene; celluloses such as triacetyl cellulose; polyamides such as nylon; acrylics such as polyacrylonitrile; polystyrenes; polyimides; polycarbonates; polyvinyl chlorides; polyurethanes; polyvinyl alcohols; paper; fluorine-containing polymers; glasses; metals; any combinations thereof; and any derivatives thereof. However, the material used to form the substrate are not limited thereto and any suitable substrate may also be used.

Although the form of the substrate is not limited, the substrate in the form of a film or sheet may have a thickness of about 10 μm to about 1000 μm.

The coating solution may be applied to the substrate by a coating method, for example, using a device of a comma coater, a roll coater, a reverse roll coater, a direct gravure coater, a reverse gravure coater, an offset gravure coater, a roll kiss coater, a reverse kiss coater, a micro gravure coater, an air doctor coater, a knife coater, a bar coater, a wire bar coater, a die coater, a dip coater, a blade coater, a brush coater, a curtain coater, a die slot coater, a cast coater, or a combination thereof. The coating method may be either of a batch type or of a continuous type.

The substrate may be previously subjected to surface treatment by fluorine coating, corona treatment, plasma treatment, ultraviolet (“UV”) treatment, or treatment with an anchor coater in consideration of adhesion of the coating layer after applying the coating solution to the substrate and drying the coated substrate.

Next, a cellulose fiber film is formed by drying the substrate coated with the coating solution. As a drying method, for example, hot air drying, infrared drying, oven drying, hot plate drying, or vacuum drying may be used.

The drying of the substrate coated with the coating solution may be performed at a temperature of 50° C. higher, for example, 60° C. or higher to sufficiently reduce residual amounts of water and the water-soluble pore-forming agent by the process of drying the coating solution. The drying may be performed at a temperature of 130° C. or lower, for example, 110° C. or lower, to inhibit denaturation of cellulose and other additives.

The cellulose fiber film (cellulose fiber nonwoven fabric) obtained by evaporating water and the water-soluble pore-forming agent may be washed with an organic solvent. Thus, the amount of the removed water-soluble pore-forming agent may be increased thereby.

The water-soluble pore-forming agent may be: for example, higher alcohols such as 1,5-pentanediol and 1-methylamino-2,3-propanediol; lactones such as ε-caprolactone, α-acetyl, and γ-butyl lactone; glycols such as diethylene glycol, 1,3-butylene glycol, and propylene glycol; glycol ethers such as triethylene glycol dimethylether, tripropylene glycol dimethylether, diethylene glycol monobutylether, triethylene glycol monomethylether, triethylene glycol butylmethylether, tetraethylene glycol dimethylether, diethylene glycol monoethylether acetate, diethylene glycol monoethylether, triethylene glycol monobutylether, tetraethylene glycol monobutylether, dipropylene glycol monomethylether, diethylene glycol monomethylether, diethylene glycol monoisopropylether, ethylene glycol monoisobutylether, tripropylene glycol monomethylether, diethylene glycol methylethylether, and diethylene glycol diethylether; glycerin; propylene carbonate; N-methyl pyrrolidone; or the like. The water-soluble pore-forming agents may be used alone or in combination of at least two thereof. Among the water-soluble pore-forming agents, propylene carbonate that may also be used as a solvent of an electrolytic solution and has little influence even when remained may be used. The amount of the water-soluble pore-forming agent in the coating solution may be adjusted according to characteristics of a desired cellulose fiber film. However, the amount of the water-soluble pore-forming agent may be 5 parts by weight or greater or 100 parts by weight or greater and 3,000 parts by weight or less or,1000 parts by weight or less based on 100 parts by weight of the cellulose fibers to form pores desired for separators. For example, the organic solvent may include toluene, acetone, methylethylketone, ethyl acetate, n-hexane, propanol, or a combination thereof. Due to a relatively higher volatilization rate, the organic solvent may be used alone or in combination of at least two thereof once or several times.

A solvent having a high affinity with water such as ethanol and methanol may be used to wash the residual water-soluble pore-forming agent. However, since the solvent absorbs moisture from the air or affects physical properties of the cellulose fiber nonwoven fabric and the sheet shape of the separator, the solvent may be used in a state where water content is controlled. A highly hydrophobic solvent such as n-hexane or toluene may be used due to low moisture absorbing property despite less effect thereof on washing the water-soluble pore-forming agent.

For this reason, a method of substituting the solvent with different types of solvent to gradually increase hydrophobicity while repeating the washing may be used. For example, the washing may be performed using solvents in the order of acetone, toluene, and n-hexane.

Then, the formed cellulose fiber film is separated from the substrate to obtain a cellulose fiber nonwoven fabric. In the case in which the cellulose fiber nonwoven fabric does not to collapse after separation, the cellulose fiber nonwoven fabric may further be dried after being separated from the substrate. A timing of separating the cellulose fiber nonwoven fabric is not limited and the cellulose fiber nonwoven fabric may also be separated from the substrate after a process of drying a fluororesin solution, which will be described later.

### Preparing of Fluorine-Containing Resin Layer Forming Composition

After obtaining the cellulose fiber nonwoven fabric, a fluorine-containing resin layer forming composition is prepared by using a fluororesin solution including the copolymer including vinylidene fluoride and the fluorine atom-containing monomer other than vinylidene fluoride.

First, a fluororesin having about 50% by weight to about 100% by weight of the copolymer including vinylidene fluoride and the fluorine atom-containing monomer other than vinylidene fluoride is diluted in a solvent capable of dissolving the fluororesin to prepare a fluororesin solution having a predetermined concentration.

The solvent capable of dissolving the fluororesin may be, for example, acetone, N-methyl-2-pyrrolidone, ethyl acetate, methylethyl ketone, N,N-dimethylformamide, or any mixture thereof, without being limited thereto. These solvents may be used alone or in combination of at least two thereof. Among these solvents, N,N-dimethylformamide may be used due to little influence on physical properties of the cellulose fiber nonwoven fabric and the sheet shape of the separator.

In the fluororesin solution, the concentration of the copolymer of vinylidene fluoride and the fluorine atom-containing monomer other than vinylidene fluoride may be from about 0.1% by weight to about 1.5% by weight. However, the concentration of the fluororesin of the copolymer is not particularly limited and may be appropriately adjusted in consideration of a thickness of the coating layer after being dried.

### Preparing of Separator by Forming Fluorine-Containing Resin Layer

After preparing the fluorine-containing resin layer forming composition, the fluorine-containing resin layer forming composition is applied to at least one surface of the cellulose fiber nonwoven fabric or at least one surface of the positive electrode and dried to form a fluorine-containing resin layer, thereby completing manufacture of the aforementioned separator.

The fluorine-containing resin layer forming composition may be applied to at least one surface of the cellulose fiber nonwoven fabric or at least one surface of the positive electrode by using the same method used in the preparation of the cellulose fiber nonwoven fabric. In this regard, after applying the fluorine-containing resin layer forming composition, the thickness of the fluorine-containing resin layer may be adjusted from about 0.1 μm to about 1 μm. The fluorine-containing resin layer forming composition applied to at least one surface of the cellulose fiber nonwoven fabric or at least one surface of the positive electrode is dried. As a drying method, the same drying method used in the preparation of the cellulose fiber nonwoven fabric may be used.

In the case in which the cellulose fiber nonwoven fabric is not separated from the substrate in the obtaining of the cellulose fiber nonwoven fabric, the cellulose fiber nonwoven fabric laminated with the fluorine-containing resin layer is separated from the substrate after drying the fluorine-containing resin layer forming composition, thereby obtaining a separator formed of the cellulose fiber nonwoven fabric laminated with the fluorine-containing resin layer. In the case in which the separator does not to collapse after separation, the separator may further be dried after being separated from the substrate.

### Method of Manufacturing Secondary Battery

A method of manufacturing a secondary battery according to another embodiment may include preparing a secondary battery by sequentially stacking a positive electrode, the aforementioned separator, and a negative electrode and injecting an electrolytic solution thereinto. The separator may be arranged such that the fluorine-containing resin layer faces the positive electrode.

The secondary battery may be manufactured according to, for example, by the following method.

The positive electrode, the negative electrode, and the separator interposed therebetween are stacked in a polypropylene cell with a screw-type lid (having an inner diameter of about 18 mm). In this regard, the separator is arranged such that the fluorine-containing resin layer laminated on one surface thereof faces the positive electrode.

An electrolytic solution of prepared by dissolving LiPF₆ in a mixed nonaqueous solvent including ethylene carbonate and ethylmethyl carbonate mixed in a ratio of 3:7 to a concentration of 1 mole per liter (mol/L) is added to the laminate as an electrolyte to prepare a laminate cell.

The nonaqueous electrolyte secondary battery according to an embodiment has excellent heat resistance, is electrochemically stable at a high voltage, and has excellent voltage resistance by using the separator including the fluorine-containing resin layer laminated on one surface of the cellulose fiber nonwoven fabric.

Since the fluorine-containing resin layer has a thickness adjusted as described above, an increase in air permeability may be prevented and movement of lithium ions between electrodes is not inhibited, resulting in improvement of battery performance (cycle characteristics).

Since the fluorine-containing copolymer including the copolymer of vinylidene fluoride and the fluorine atom-containing monomer other than vinylidene fluoride has a polar group on the surface thereof, the fluorine-containing resin layer including the fluorine-containing copolymer having the polar group has excellent adhesion to the cellulose fiber nonwoven fabric inhibiting separation therefrom.

Hereinafter, one or more embodiments will be described in detail with reference to the following examples and comparative examples. However, these examples and comparative examples are not intended to limit the purpose and scope of the one or more embodiments of the present disclosure.

### EXAMPLES

### Example 1

### Manufacture of Secondary Battery

Cellulose fibers, propylene carbonate (Toho Chemical Industry, Co., Ltd.) as a water-soluble pore-forming agent, and polyvinyl alcohol (degree of polymerization: 3500, Wako Pure Chemical Industries Co., Ltd.) as a binder were mixed to final concentrations of 0.5% by weight, 2% by weight, and 0.005% by weight, respectively, and the mixture was stirred to prepare a coating solution.

In this regard, the cellulose fibers were derived from acetic acid bacteria, had an average fiber diameter of 30 nanometers (nm), and included less than 1% by weight of cellulose fibers having a fiber diameter of 1 micrometer (μm) or greater.

The coating solution was applied to a polyester substrate by using an applicator at an interval of 1.2 mm and dried in an oven at 85° C. to remove water. Then, the formed film was separated from the polyester substrate to obtain a cellulose fiber nonwoven fabric having a thickness of 15 μm.

A dicarboxylic acid-modified vinylidene fluoride/hexafluoro propylene copolymer (Kureha Corporation, KF polymer (#9300)), as a fluororesin, was dissolved in N,N-dimethylformamide to a concentration of 0.5% by weight to prepare a fluorine-containing resin layer forming composition of a fluororesin solution including 100% by weight of the dicarboxylic acid-modified vinylidene fluoride/hexafluoro propylene copolymer having a carboxylic group as a polar group.

The fluororesin solution having 100% by weight of the modified vinylidene fluoride/hexafluoro propylene copolymer having the carboxylic group was applied to one surface of the cellulose fiber nonwoven fabric by using a wire bar (winding No. 5). The applied cellulose fiber nonwoven fabric was dried in an oven at 85° C., washed with toluene, and dried on a hot plate of 85° C. to obtain a separator having a coating layer of the dicarboxylic acid-modified vinylidene fluoride/hexafluoro propylene copolymer having the carboxyl group as a polar group formed on one surface of the cellulose fiber nonwoven fabric.

A laminate cell (nonaqueous electrolyte secondary battery) was manufactured by using the separator as follows.

A positive electrode, the separator, and a negative electrode are sequentially laminated such that the coating layer, which is formed of the dicarboxylic acid-modified vinylidene fluoride/hexafluoro propylene copolymer having the carboxyl group as a polar group, of the separator faces the positive electrode. An electrolytic solution was injected into the laminate (refer to FIG. 1C) to prepare a laminate cell.

In this case, the positive electrode was lithium nickel cobalt aluminum oxide (LiNi_{0.85}Co_{0.14}Al_{0.01}O₂), the negative electrode was artificial graphite, and the electrolytic solution was an LiPF₆ solution having a concentration of 1 mole per liter (mol/L) and prepared by using an ethylenecarbonate/diethylcarbonate solvent (mixed in 3:7).

### Example 2

### Manufacture of Secondary Battery

A secondary battery was manufactured in the same manner as in Example 1, except that the dicarboxylic acid-modified vinylidene fluoride/hexafluoro propylene copolymer (Kureha Corporation, KF polymer (#9300), as the fluororesin, was dissolved in N,N-dimethylformamide to a concentration of 1.0% by weight instead of 0.5% by weight.

### Example 3

### Manufacture of Secondary Battery

A secondary battery was manufactured in the same manner as in Example 1, except that a monocarboxylic acid-modified vinylidene fluoride/hexafluoro propylene copolymer (Kureha Corporation, KF polymer (#9700) was used as the fluororesin instead of the dicarboxylic acid-modified vinylidene fluoride/hexafluoro propylene copolymer (Kureha Corporation, KF polymer (#9300)).

### Comparative Example 1

### Manufacture of Secondary Battery

A secondary battery was manufactured in the same manner as in Example 1, except that a laminate cell (nonaqueous electrolyte secondary battery) was prepared using a cellulose fiber nonwoven fabric (no coating layer) as the separator.

### Comparative Example 2

### Manufacture of Secondary Battery

A secondary battery was manufactured in the same manner as in Example 1, except that a vinylidene fluoride homopolymer (no polar group) (Kureha Corporation, KF polymer (#7300)) was used as the fluororesin instead of the dicarboxylic acid-modified vinylidene fluoride/hexafluoro propylene copolymer (Kureha Corporation, KF polymer (#9300)).

### Comparative Example 3

### Manufacture of Secondary Battery

A secondary battery was manufactured in the same manner as in Example 1, except that the dicarboxylic acid-modified vinylidene fluoride/hexafluoro propylene copolymer (Kureha Corporation, KF polymer (#9300)), as the fluororesin, was dissolved in N,N-dimethylformamide to a concentration of 2.0% by weight instead of 0.5% by weight.

### Comparative Example 4

### Manufacture of Secondary Battery

A secondary battery was manufactured in the same manner as in Example 1, except that a laminate cell (nonaqueous electrolyte secondary battery) was prepared by using a fluororesin particle-containing cellulose fiber nonwoven fabric (no coating layer), as a separator, formed of a fluororesin particle-containing coating solution, which is prepared by adding a vinylidene fluoride/hexafluoropropene copolymer (Kureha Corporation, water dispersed particulate VDF-HFP), as water dispersed vinylidene fluoride-based particles, to the coating solution prepared in Example 1 such that a solid content thereof was 20% by weight based on the solid content of cellulose fibers, and stirring the mixture.

### Comparative Example 5

### Manufacture of Secondary Battery

A secondary battery was manufactured in the same manner as in Example 1, except that a laminate cell (nonaqueous electrolyte secondary battery) was prepared using a separator laminated with a coating layer formed by applying alumina particles to a porous polyethylene film having a thickness of 14 μm to a thickness of 4 μm and drying the alumina particles.

### Analysis Example 1

### Scanning Electron Microscope (“SEM”) Image

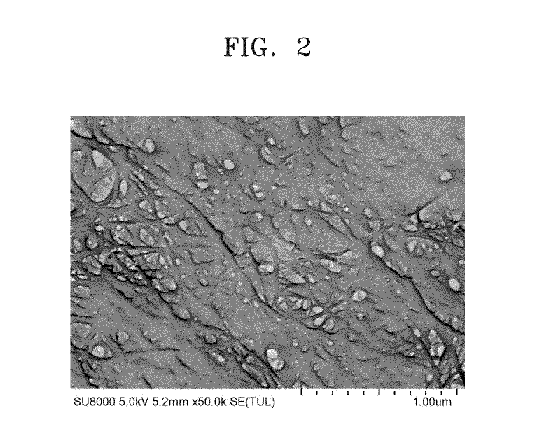

A cross-section of the separator facing the positive electrode of the secondary battery prepared in Example 1 was analyzed by using a scanning electron microscope (“SEM”). An SEM manufactured by Hitachi High-Technologies (SU-8020) was used in the analysis. The results are shown in FIG. 2.

Referring to FIG. 2, it may be configured that a thin film coating layer having a thickness of less than 1 μm is formed on cellulose fibers.

### Analysis Example 2

### FTIR Spectrum

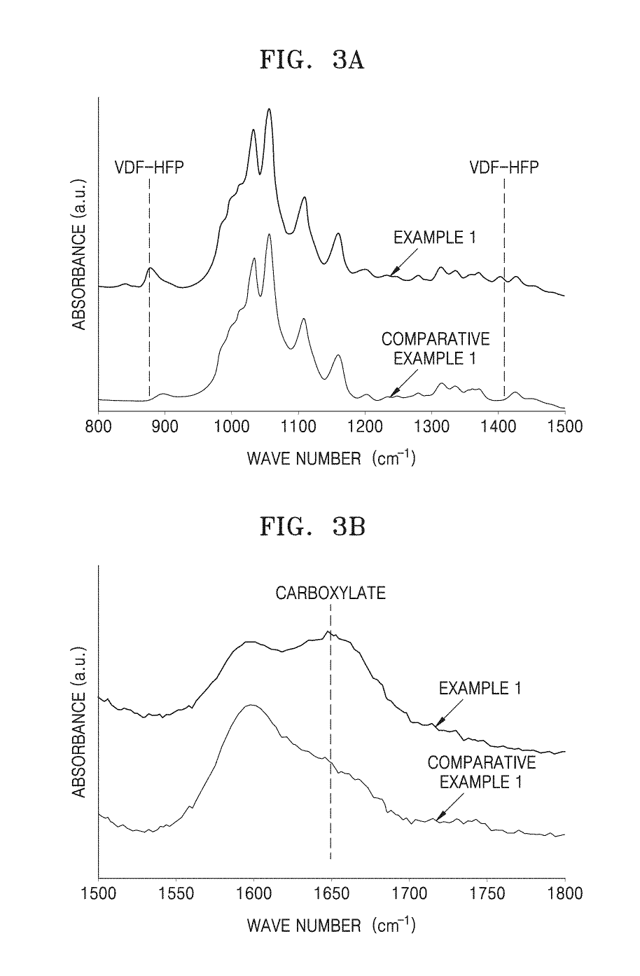

Surfaces of the separators facing the positive electrodes of the secondary batteries manufactured according to Example 1 and Comparative Example 1 were subjected to nanoscale FTIR spectrum analysis. A Nicolet iS10 manufactured by Thermo Scientific was used for the analysis. The results are shown in FIGS. 3A and 3B.

Referring to FIGS. 3A and 3B, the surface of the separator facing the positive electrode of the secondary battery according to Example 1 exhibited peaks at wave numbers of about 880 inverse centimeters (cm⁻¹), about 1650 cm⁻¹, and about 1400 cm⁻¹. Thus, it may be confirmed that the coating layer formed of the dicarboxylic acid-modified vinylidene fluoride/hexafluoro propylene copolymer was present.

In comparison therewith, the surface of the separator facing the positive electrode of the secondary battery manufactured according to Comparative Example 1 did not show these peaks.

### Evaluation Example 1

### Evaluation of Physical Properties and Electrochemical Properties of Separator

Physical properties of the separators included in the secondary batteries manufactured according to Examples 1 to 3 and Comparative Examples 1 to 5 were evaluated according to the following methods.

### Thickness (μm) of Coating Layer

Thicknesses (μm) of the coating layers were obtained using a micrometer (Teclock Corporation, Product name: PG-02J) and Equation 1 below. The results are shown in Table 1.

Thickness(μm)of coating layer=[(thickness(μm)of separator)−(thickness(μm)of cellulose fiber nonwoven fabric)]

Air Permeability (Seconds (Sec)/100 Milliliters (mL))

The separator was cut to a width of 80 mm and a length of 80 mm to obtain a sample. The sample was tightly fixed to a circular hole having an outer diameter of 28.6 mm and a time during which 100 mL of air permeates therethrough was measured using a Gurley type Densometer (TOYO Electronics Co., Ltd.) according to JIS P8117 to measure air permeability (sec/100 mL). The results are shown in Table 1 below.

### Heat Resistance Temperature (° C.)

The separator was cut to a width of 3 mm and a length of 30 mm (measurement portion: 20 mm, TD direction being a major axis) to obtain a sample. The sample was heated to 350° C. at a rate of 10° C./minute and measurement was performed under a load of 2 mN/μm per thickness using a thermal mechanical analyzer (EXSTAR 6000, Seiko Instruments). A point where deformation of 5% or greater was measured as a heat resistance temperature (° C.). The results are shown in Table 1.

### Cycle Characteristics (Capacity Retention Ratio (%)

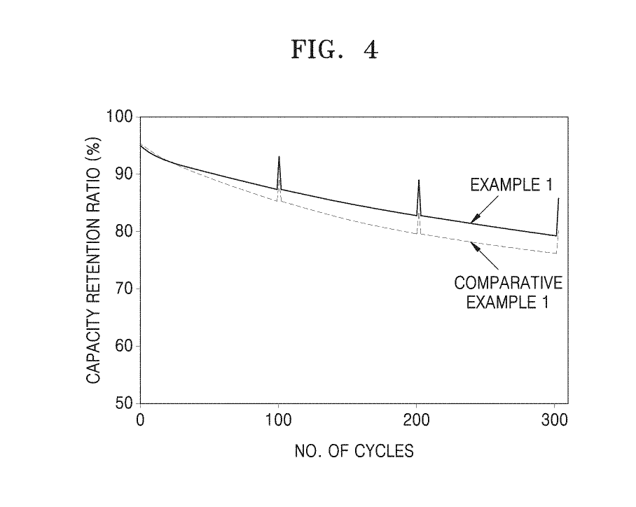

The laminate cell (secondary battery) was installed in a thermostat in which a temperature inside a container was set to 25° C. and charged/discharged (4.35 volts (V) to 2.75 V) at 10 hour-rate for formation. Then, an initial capacity of a value obtained after one cycle of constant current-constant voltage charging at 2-hour rate and constant current discharging at 5-hour rate was identified. Then, charging/discharging (4.35 V to 2.8 V) were performed 300 times at 1-hour rate. A ratio of a value obtained by constant current-constant voltage charging at 2-hour rate and constant current discharging at 5-hour rate at every 100 cycles of 1-hour rate to the initial capacity was referred to as capacity retention ratio (%). The results are shown in Table 1 and partially shown in FIG. 4.

### Adhesion (Visual Observation)

Adhesion of the fluorine-containing resin layer to the cellulose fiber nonwoven fabric was evaluated according to the following criteria by visual observation of an interface therebetween by applying the fluorine-containing resin layer forming composition of the fluororesin solution to one surface of the cellulose fiber nonwoven fabric and drying the surface. The results are shown in Table 1.

### Evaluation Criteria

O: The fluorine-containing resin layer was separated.
X: The fluorine-containing resin layer was not separated.

TABLE 1

| | Example | | | Comparative Example | | | | |
|---|---|---|---|---|---|---|---|---|
| | 1 | 2 | 3 | 1 | 2 | 3 | 4 | 5 |
| Thickness of coating | 0.4 | 0.9 | 0.8 | 0 | 0.6 | 1.4 | 0 | 4 |
| layer (μm) | | | | | | | | |
| Air permeability | 202 | 353 | 381 | 163 | 395 | 1265 | 683 | 198 |
| (sec/100 mL) | | | | | | | | |
| Heat resistance | 322 | 321 | 324 | 320 | 323 | 326 | 317 | 165 |
| temperature (° C.) | | | | | | | | |
| Capacity retention | 86 | 83 | 82 | 80 | — | 66 | 75 | 84 |
| ratio (%) | | | | | | | | |
| Adhesion (visual | ∘ | ∘ | ∘ | — | x | ∘ | — | — |
| observation) | | | | | | | | |

In Table 1, “0” indicates no coating layer and “-” indicates no evaluation.

Based on the results shown in Table 1, it may be confirmed that the secondary batteries manufactured according to Examples 1 to 3 have excellent heat resistance, voltage resistance, electrochemical stability at a high voltage, and adhesion in comparison with the secondary batteries manufactured according to Comparative Examples 1 to 5.

Since the thickness of the fluorine-containing resin layer of the separator included in each of the secondary batteries manufactured according to Examples 1 to 3 is from about 0.1 μm to about 1 μm, an increase in air permeability may be inhibited and movement of lithium ions between electrodes may not be blocked. Thus, the secondary batteries may have excellent cycle characteristics.

Since the fluorine-containing resin layer (coating layer) of the separator of each of the secondary batteries manufactured according to Examples 1 to 3 includes a vinylidene fluoride-based copolymer and has a carboxyl group as a polar group on the surface thereof, the fluorine-containing resin layer including the copolymer has excellent adhesion to the cellulose fiber nonwoven fabric and separation thereof may be prevented.

On the contrary, since a fluorine-containing resin layer (coating layer) is not located on one surface of the cellulose fiber nonwoven fabric of the separator included in the secondary battery manufactured according to Comparative Example 1, it is considered that the secondary battery had poor voltage resistance and electrochemical stability. Thus, it may be confirmed that excellent battery performance cannot be realized in the secondary battery manufactured according to Comparative Example 1.

Since the fluororesin of the fluorine-containing resin layer of the separator included in the secondary battery manufactured according to Comparative Example 2 does not have a polar group, the fluorine-containing resin layer is separated from the cellulose fiber nonwoven fabric, i.e., has poor adhesion.

Since the thickness of the fluorine-containing resin layer of the separator included in the secondary battery manufactured according to Comparative Example 3 is not within the range described above, it is considered that air permeability increases and movement of lithium ions between electrodes is blocked in the secondary battery. Thus, it may be confirmed that excellent battery performance cannot be realized in the secondary battery manufactured according to Comparative Example 3.

Since a coating layer of the fluorine-containing resin layer is not formed on the separator of the secondary battery manufactured according to Comparative Example 4, and particles of fluororesin are contained in the cellulose fiber nonwoven fabric instead, it is considered that the secondary battery had poor voltage resistance and electrochemical stability. Thus, it may be confirmed that excellent battery performance cannot be realized in the secondary battery manufactured according to Comparative Example 4.

Since the polyethylene porous film was used instead of the cellulose fiber nonwoven fabric as a raw material constituting the separator included in the secondary battery manufactured according to Comparative Example 5, the secondary battery had poor heat resistance.

Since the separator according to an embodiment includes the cellulose fiber nonwoven fabric, and the fluorine-containing resin layer including the fluorine-containing copolymer located on at least one surface of the cellulose fiber nonwoven fabric, and the fluorine-containing copolymer includes the copolymer including vinylidene fluoride and the fluorine atom-containing monomer other than vinylidene fluoride, the separator may have excellent heat resistance, voltage resistance, electrochemical stability at a high voltage, and adhesion, and the secondary battery including the separator may have excellent battery performance (cycle characteristics).

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A separator comprising:
a cellulose fiber nonwoven fabric; and
a fluorine-containing resin layer comprising a fluorine-containing copolymer, the fluorine-containing resin layer being disposed on a surface of the cellulose fiber nonwoven fabric,
wherein the fluorine-containing copolymer comprises a copolymer comprising vinylidene fluoride and a fluorine-containing monomer other than vinylidene fluoride.

2. The separator of claim 1, wherein the fluorine-containing resin layer comprises a polar group capable of forming a hydrogen bond with a cellulose fiber on a surface of the fluorine-containing resin layer.

3. The separator of claim 1, wherein the fluorine-containing resin layer comprises a fluorine-containing copolymer comprising the fluorine-containing monomer other than vinylidene fluoride, a polar group-containing monomer, or a monomer of a combination thereof.

4. The separator of claim 3, wherein the fluorine-containing monomer other than vinylidene fluoride comprises trifluoroethylene, chlorotrifluoroethylene, tetrafluoroethylene, hexafluoropropylene, fluoromethylvinylether, fluoroethylvinylether, fluoropropylvinylether, or a combination thereof.

5. The separator of claim 3, wherein the polar group-containing monomer comprises a halogen group, a hydroxyl group, an amino group, a nitro group, a carboxyl group, a formyl group, a substituted or unsubstituted C1-C10 alkoxy group, a substituted or unsubstituted C1-C10 ester group, a nitrile group, or a combination thereof.

6. The separator of claim 3, wherein the polar group-containing monomer comprises acrylic acid, methacrylic acid, furoic acid, crotonic acid, itaconic acid, maleic acid, fumaric acid, citraconic acid, an anhydrate thereof, a monoester thereof, or a combination thereof.

7. The separator of claim 1, wherein an amount of the fluorine-containing monomer other than vinylidene fluoride is from about 1% by weight to about 50% by weight, based on a total weight of the fluorine-containing copolymer.

8. The separator of claim 1, wherein a molar ratio of the vinylidene fluoride to the fluorine-containing monomer other than vinylidene fluoride is from about 70:30 to about 99.9:0.1.

9. The separator of claim 1, wherein an amount of the fluorine-containing copolymer is from about 50% by weight to about 100% by weight, based on a total weight of the fluorine-containing resin layer.

10. The separator of claim 3, wherein an amount of the polar group-containing monomer is from about 0% by weight to about 10% by weight, based on a total weight of the fluorine-containing copolymer.

11. The separator of claim 1, wherein a weight average molecular weight of the fluorine-containing copolymer is from about 1,000 grams per mole to about 10,000,000 grams per mole, when determined by gel permeation chromatography in tetrahydrofuran at 40° C. using polystyrene standards.

12. The separator of claim 1, wherein a thickness of the fluorine-containing resin layer is from about 0.1 micrometers to about 1 micrometer.

13. The separator of claim 1, wherein the cellulose fiber nonwoven fabric comprises a cellulose fiber derived from a microorganism.

14. The separator of claim 1, wherein the cellulose fiber nonwoven fabric comprises 90% by weight or greater of cellulose fibers having an average fiber diameter of 1 micrometer or less.

15. The separator of claim 1, wherein a thickness of the cellulose fiber nonwoven fabric is from about 5 micrometers to about 30 micrometers.

16. The separator of claim 1, wherein an air permeability of the separator is from about 50 seconds per 100 milliliters to about 500 seconds per 100 milliliters.

17. A secondary battery comprising:
a positive electrode;
a negative electrode; and
the separator according to claim 1 interposed between the positive electrode and the negative electrode.

18. The secondary battery of claim 17, wherein the fluorine-containing resin layer is between the positive electrode and the cellulose fiber nonwoven fabric, between the negative electrode and the cellulose fiber nonwoven fabric, or a combination thereof.

19. The secondary battery of claim 18, wherein the fluorine-containing resin layer is on a surface of the positive electrode facing the separator.

20. The secondary battery of claim 18, wherein the fluorine-containing resin layer is on a surface of the separator facing the positive electrode.

21. A method of preparing a separator, the method comprising:
coating a solution comprising a cellulose fiber suspension and a water-soluble pore-forming agent to form a cellulose fiber nonwoven fabric;
combining a copolymer comprising vinylidene fluoride and a fluorine-containing monomer other than vinylidene fluoride to form a fluorine-containing resin layer forming composition; and
coating the fluorine-containing resin layer forming composition on a surface of the cellulose fiber nonwoven fabric to form a coated composition; and
drying the coated composition to prepare the separator of claim 1.

22. The method of claim 21, wherein the coating a solution comprising a cellulose fiber suspension and a water-soluble pore-forming agent to form the cellulose fiber nonwoven fabric comprises:
applying the coating solution comprising the cellulose fiber suspension and the water-soluble pore-forming agent to a substrate;
drying the coated solution to form a cellulose fiber film; and
separating the cellulose fiber film from the substrate to form the cellulose fiber nonwoven fabric.

23. The method of claim 22, wherein the substrate comprises a polyester substrate, a polyolefin substrate, a cellulose substrate, a polyamide substrate, an acrylic substrate, a polystyrene polymer, a polyimide substrate, a polycarbonate substrate, a polyvinyl chloride substrate, a polyurethane substrate, a polyvinyl alcohol substrate, a paper substrate, a fluorine-containing polymer substrate, a glass substrate, a metal substrate, or a combination thereof.

24. The method of claim 22, wherein the water-soluble pore-forming agent comprises an alcohol, a lactone, a glycol, a glycol ether, glycerin, propylene carbonate, N-methyl pyrrolidone, or a combination thereof.

25. The method of claim 22, wherein the drying of the substrate coated with the coating solution is performed at a temperature from about 50° C. to about 130° C.

26. The method of claim 21, wherein a concentration of the copolymer comprising vinylidene fluoride and a fluorine-containing monomer other than vinylidene fluoride is from about 0.1% by weight to about 1.5% by weight in the fluorine-containing resin layer forming composition, based on a total weight of the fluorine-containing resin layer forming composition.

27. A method of manufacturing a secondary battery, the method comprising:
sequentially laminating a positive electrode, the separator according to claim 1, and a negative electrode to form a laminate; and
disposing an electrolytic solution in the laminate to manufacture the secondary battery,
wherein a fluorine-containing resin layer of the separator faces the positive electrode.
